(19) United States
(12) Patent Application Publication
(10) Pub. No.: US 2024/0279385 A1
(43) Pub. Date: Aug. 22, 2024

(54) POLYASPARTIC COMPOSITIONS

(71) Applicant: Vencorex France SAS, Saint-Priest, Lyon (FR)

(72) Inventors: Arthur BOUCHUT, Lyon (FR); Remi MARTINEZ, Lyon (FR)

(21) Appl. No.: 18/566,710

(22) PCT Filed: Jun. 3, 2022
(86) PCT No.: PCT/EP2022/065174

§ 371 Date: Dec. 4, 2023

(30) Foreign Application Priority Data
Jun. 4, 2021 (FR) FR2105882

(51) Int. Cl. C08G 18/64; C08G 18/72; C08G 18/78; C08G 18/79; C09D 175/04; C09J 175/04

(52) U.S. Cl. CPC C08G 18/6415; C08G 18/722; C08G 18/725; C08G 18/7831; C08G 18/7837; C08G 18/792; C09D 175/04; C09J 175/04

(57) ABSTRACT

The invention relates to compositions for coating preparations comprising at least one polyaspartic ester compound, at least one isocyanate compound and optionally at least one additive.

### TECHNICAL FIELD

The invention relates to a composition for preparing coatings comprising a polyaspartic ester and an isocyanate compound.

The invention also relates to a process for preparing such compositions as well as to the use of such compositions as protective coatings.

The invention also relates to a protective coating comprising the polyaspartic compositions.

In particular, the invention relates to a composition for preparing a coating having improved flexibility and improved pot life of a formulation for paint or varnish, and the viscosity of which is reduced.

### STATE OF THE ART

The coatings comprising polyaspartic esters are mainly used for their rapid crosslinking, resistance to abrasion and corrosion and/or their use in formulations with a high solids content.

As an example of these compositions comprising polyaspartic esters, we can cite patent EP 0573860, which describes a composition comprising a polyisocyanate, a polyaspartic ester and a catalyst. Patent application WO 202016292 describes another type of composition comprising at least one polyaspartic ester, at least one isocyanate prepolymer and a catalyst.

Generally speaking, compositions comprising polyaspartic esters have very short pot lives and are very inflexible (elongation at break <50%). Additionally, some of these polyaspartic compositions comprise solvents or catalysts, which can cause other problems.

Pot life times are generally improved by:
using solvents in compositions comprising polyaspartic esters, which makes it possible to reduce the viscosity of the composition and its crosslinking speed,
using low viscosity reactive diluents generally in small amounts (<30 wt. %).

The use of solvents or reactive diluents in small amounts makes it possible to solve the problem of a short pot life, but does not make it possible to improve the flexibility of a composition comprising polyaspartic esters.

To solve this particular problem of flexibility, elastomeric isocyanate prepolymer compounds are often added to the polyaspartic compositions. These isocyanate prepolymers generally have a low NCO content (<13%) and a high viscosity (>1500 mPa·s), which limits their potential for application.

As a result, these polyaspartic compositions generally comprise significant amounts of solvent in order to lower or control their viscosity and/or improve their pot life. These solvents are usually volatile organic compounds (VOCs) or sources of such VOCs.

Moreover, the addition of catalysts proves problematic given their toxicity towards the health of handlers or the environment.

There is therefore a need to find novel isocyanate-based polyaspartic compositions without solvents or catalysts that are flexible (elongation at break >50%) and in which the isocyanate part has low viscosity (<1500 mPa·s).

Thus, the present invention provides a composition for preparing a coating that is particularly advantageous in the field of ground covering or wind power.

The invention makes it possible to provide a solution to the various problems related to compositions for preparing coatings in the state of the art, in particular the problems related to the difficulty of application when the composition is too viscous, but also the problems linked to the ductility of coatings when they are not flexible enough.

### DISCLOSURE OF THE INVENTION

The invention relates to compositions for preparing coatings having improved elongation, the isocyanate part of which has an NCO content greater than 13% and an acceptable viscosity, that is to say less than 1500 mPa·s at 25° C. Improved elongation property is understood to mean an elongation at break greater than 50%.

In particular, the invention relates to a composition for preparing coatings comprising:
at least one polyaspartic ester compound (a),
at least one isocyanate compound (b),
optionally at least one additive (c).

The invention relates more specifically to a composition for preparing a coating wherein the isocyanate compound (b) is a mixture of isocyanates comprising:
at least one allophanate (b1) and
at least one polyfunctional isocyanate (b2) and wherein the mass ratio (b1)/(b2) is between 50/50 and 99/1.

Preferentially, the mass ratio (b1)/(b2) is between 55/45 and 95/5. Even more preferentially, the mass ratio (b1)/(b2) is between 60/40 and 95/5.

The molar ratio between mixtures (b) and (a) defined by the number of NCO functions for (b) and the number of NH functions for (a). The ratio (b) to (a) is between 0.7 and 1.3, preferentially 0.8 to 1.2, more preferentially 0.9 to 1.1 or even more preferentially is equal to 1. The number of NCO functions of the compound (b) is equal to the sum of the number of NCO functions of the compound (b1) and the compound (b2).

The polyaspartic ester (a) preferably has an NH group content of between 2% and 8% by mass, more preferentially between 3% and 7%.

The polyaspartic ester (a) preferably has a viscosity ranging from 500 to 4000 mPa·s.

The polyaspartic ester (a) according to the invention can be obtained by the Michael reaction of a system comprising a polyamine and an ester. This ester is preferably a maleate or a fumarate or a mixture thereof.

According to the invention, the term “polyamine” refers to compounds comprising at least two primary and/or secondary free amine groups. The term “polyamine” also includes polymers comprising at least two pendant and/or terminal amine-containing groups.

The reaction to prepare the polyaspartic ester (a) can be carried out without a solvent or in the presence of a suitable solvent. This solvent is preferably one or more alcohols, ethers, acetates, ketones or a mixture thereof.

The alcohol(s) used as solvents may for example be methanol, ethanol, butyl glycol and propanol.

The acetate used as a solvent is preferably n-butyl acetate.

The ketone used as a solvent is preferably the methyl ethyl ketone dialkane.

The polyaspartic ester (a) is preferably a polyaspartic ester according to general formula (I):

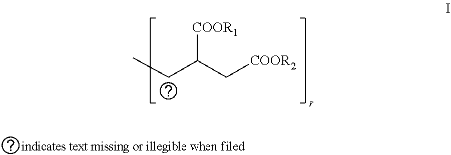

wherein
X represents an aliphatic chain or a polyether chain,
R₁ and R₂ are, independently of each other, an organic group that is inert with respect to an isocyanate group at normal atmospheric pressure (approximately 100 Pa) and at 100° ° C. or less,
n represents an integer greater than or equal to 2.

Preferably, R₁ and R₂ are, independently of each other, an alkyl residue having 1 to 10 carbon atoms, more preferentially R₁ and R₂ are, independently of each other, chosen from the methyl, ethyl or butyl groups.

n is preferably an integer between 2 and 4, more preferably 2.

Preferably, in general formula (I), X consists of one or more of the following residues: a polyether residue, a linear alkyl residue, a branched alkyl residue and a cycloalkyl residue.

In general formula (I), if n=2, the polyaspartic ester (a) is prepared by reaction of a polyamine of formula (I.a) and a maleate and/or a fumarate of formula (I.b).

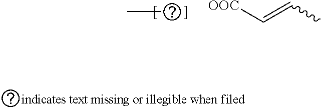

The polyamine of formula (I.a) is preferably chosen from ethylenediamine, 1,2-diaminopropane, 1,4-diaminobutane, 1,3-diaminopentane, 1,6-diaminohexane, 2,5-diamino-2,5-dimethylhexane, 1,6-diaminohexane, 2,2,4-trimethyl-1,6-diaminohexane, 2,4,4-trimethyl-1,6-diaminohexane, 1,11-diaminoundecane, 1,12-diaminododecane, 1,3-cyclohexanediamine and 1,4-cyclohexanediamine, amino-3,3,5-trimethyl-5-aminomethylcyclohexane, 2,4-hexahydrotoluenediamine, 2,6-hexahydrotoluenediamine, 2,4′-diamino-dicyclohexylmethane, 4,4′-diamino-dicyclohexylmethane, 3,3′-dialkyl-4,4′-diaminodicyclohexylmethane, 2,4,4′-triamino-5-methyldicyclohexylmethane, 2-methyl-1,5-pentanediamine, 1,3-xylenediamine and 1,4-xylenediamine; and more preferably chosen from 1,4-aminobutane, 1,6-diaminohexane, 2,2,4-trimethyl-1,6-diaminohexane, 2,4,4-trimethyl-1,6-diaminohexane, amino-3,3,5-trimethyl-5-aminomethylcyclohexane, 4,4′-diamino-dicyclohexylmethane, 3,3′-dialkyl-4,4′-diaminodicyclohexylmethane, 2-methyl-1,5-pentanediamine; even more preferably chosen from 2-methyl-1,5-pentanediamine, amino-3,3,5-trimethyl-5-aminomethylcyclohexane, 2,4′-diamino-dicyclohexylmethane, 4,4′-diamino-dicyclohexylmethane and 3,3′-dialkyl-4,4′-diaminodicyclohexylmethane, polyetherpolyamine with functionality 2 and number-average molar mass (Mn) less than 1000 g/mol.

The maleate and/or fumarate of formula (I.b) is preferably chosen from dimethyl maleate, diethyl maleate, dibutyl maleate, dimethyl fumarate, diethyl fumarate and dibutyl fumarate.

The molar ratio between the maleate and/or the fumarate (I.b) and the polyamine (I.a) is preferably 2:1.

The molar ratio between the olefinic double bonds of the maleate and/or fumarate (I.b) and the primary amine groups of the polyamine (I.a) is preferably 1:1.

The product obtained from the reaction between (I.a) and (I.b) is preferably purified by distillation in order to obtain the polyaspartic ester (a).

The reaction components (I.a) and (I.b) may or may not comprise a solvent, and preferably comprise a solvent.

The solvent is preferably one or more of the following solvents: methanol, ethanol, propanol and/or dioxane.

The polyaspartic ester(s) (a) of general formula (I) are one or more polyaspartic esters or a mixture of polyaspartic esters:
of general formula (II) and/or,

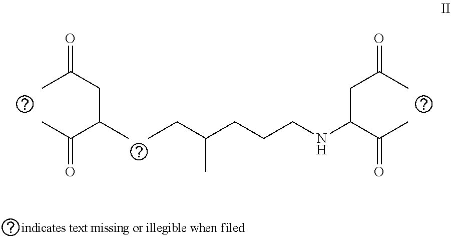

of general formula (III) and/or

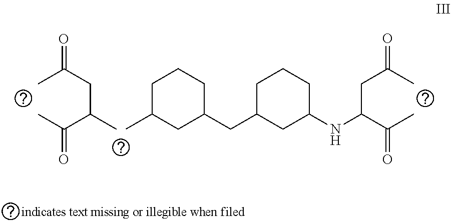

of general formula (IV) and/or

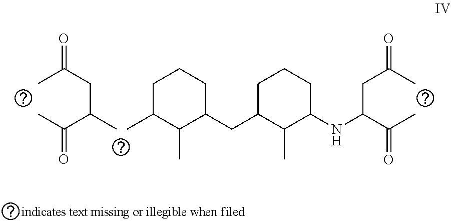

of general formula (V)

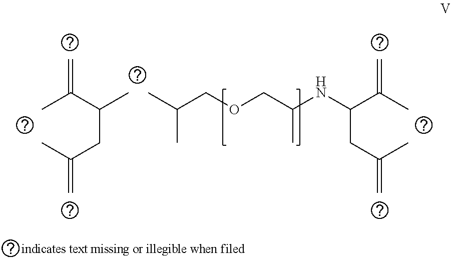

wherein groups R₁ and R₂ are independently of each other a C₁-C₁₀ alkyl group and u is an integer between 1 and 10.

Preferentially, u is an integer between 2 and 6, even more preferentially, u is an integer between 2 and 4.

Preferably, in general formulas (II), (III), (IV) and (V), the groups R₁ and R₂ are, independently of each other, one or more methyl, ethyl or butyl groups, preferably, R₁ and R₂ are ethyl groups.

The polyaspartic ester (a) is more preferably chosen from the compounds that react with the isocyanates described in patents US 512617, US 523674, U.S. Pat. Nos. 5,489,704, 5,243,012, U.S. Pat. Nos. 5,736,604, 6,458,293, 6,833,424, 7,169,876 or US 2006/0247371.

The polyaspartic ester (a) is even more preferably chosen from tetraethyl N,N′-(methylenedicyclohexane-4,1-diyl)bis-DL-aspartate, tetraethyl N,N′-(methylenebis(2-methyl-cyclohexane-4,1-diyl) bis-DL-aspartate or tetraethyl N, N′-(2-methylpentane)bis-DL-aspartate

According to the invention, the allophanate (b1) has an NCO functionality equal to 2.1+0.3 or preferentially 2.1+0.2 or preferentially 2.1+0.1 and has general formula (VI)

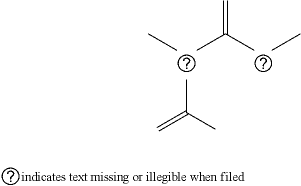

wherein
R₃ and R₄, which may be identical or different, represent a hydrocarbon group comprising at least one function chosen from an isocyanate, carbamate, urea, biuret uretinedione, acylurea, isocyanurate, blocked isocyanate or allophanate function,
R₅ represents the residue of a molecule comprising an OH function after reaction of this OH function with an isocyanate function and the molecule of which containing an OH group can also comprise an ether or polyether function and chosen from a silanol, a C₁₂-C₂₀ linear aliphatic monoalcohol, a C₁₂-C₂₀ branched aliphatic monoalcohol, a C₂-C₄₀ linear diol or a C₃-C₄₀ branched diol of which at least one of the hydroxyl groups is substituted and which has general formula (VII):

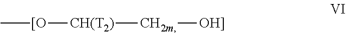

wherein T₁ represents a C₁-C₂₀ linear alkyl group, a C₁-C₂₀ branched alkyl group, a group of formula T₃—CO—CH₃ wherein T₃ represents a C₁-C₂₀ linear alkyl group or a C₁-C₂₀ branched alkyl group; T₂ represents hydrogen or an alkyl group, preferably a C₁-C₈ alkyl group or an ether group of formula —CH₂OT₄ wherein T₄ represents a hydrocarbon chain, in particular a polyalkylene chain or a polyoxyalkylene chain or a polyoxyethylene chain; m represents an integer ranging from 1 to 50.

Blocked isocyanate function is understood to mean any isocyanate function having reacted with an isocyanate function blocking agent. The different blocking reactions are reversible and the unblocking conditions are known to those skilled in the art.

Preferably, T₄ represents a polyalkylene chain or a polyoxyalkylene chain or a polyoxyethylene chain.

Preferably, the allophanate (b1) is a compound of general formula (VI) wherein R₃ and R₄, which may be identical or different, represent a group comprising at least one function chosen from an isocyanate, carbamate, urea, biuret uretinedione, acylurea, isocyanurate, blocked isocyanate or allophanate function and chosen from an aliphatic, cycloaliphatic, heterocyclic or aromatic hydrocarbon group. Preferably, R₃ and R₄ may be identical or different and represent an aliphatic hydrocarbon group comprising at least one function chosen from an isocyanate, carbamate, urea, biuret uretinedione, acylurea, isocyanurate, blocked isocyanate or allophanate function.

Blocked isocyanate function is understood to mean any isocyanate function having reacted with an isocyanate function blocking agent. The different blocking reactions are reversible and the unblocking conditions are known to those skilled in the art.

According to the invention, the allophanate (b1) can be a homo-allophanate, with R₃ and R₄ being identical, or else the allophanate (b1) can be a mixed allophanate, with R₃ and R₄ being different.

According to the invention, the coating composition may comprise a mixture of different allophanates (b1) of general formula (VI).

The mixture of allophanates (b1) may comprise at least 25% by mass, advantageously at least 33% by mass, preferably at least 50% by mass of at least one monoallophanate.

The mixture of allophanates (b1) may also comprise at least one allophanate chosen from a bis-allophanate, a tris-allophanate, one or more allophanate oligomers, as well as a minority of isocyanate carbamate resulting from the reaction of compounds of formula RANCO and an alcohol of formula R₅OH or isocyanate carbamate resulting from the reaction of compounds of formula R₃NCO and an alcohol of formula R₅OH or the mixture of isocyanate carbamates resulting from the reaction of compounds of formula RANCO and formula R₃NCO and an alcohol of formula R₅OH.

According to the invention, the compound (b2) is a polyfunctional isocyanate, preferably at least one polyfunctional isocyanate of general formula (VIII):

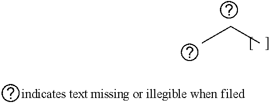

wherein
R₆, R₇ and R₈ independently represent a hydrocarbon group or an aliphatic, cycloaliphatic, heterocyclic or aromatic heterocarbon group, comprising at least one function chosen from an isocyanate, carbamate, urea, biuret, uretinedione, acylurea, isocyanurate, blocked isocyanate or allophanate function,
p represents an integer chosen from 0, 1 or 2;
Y represents a group chosen from an isocyanurate group of formula (Y₁), an imino oxadiazine dione group of formula (Y₂), an oxadiazine trione group of formula (Y₃), a biuret group of formula (Y₄) or a group of formula (Y₅):

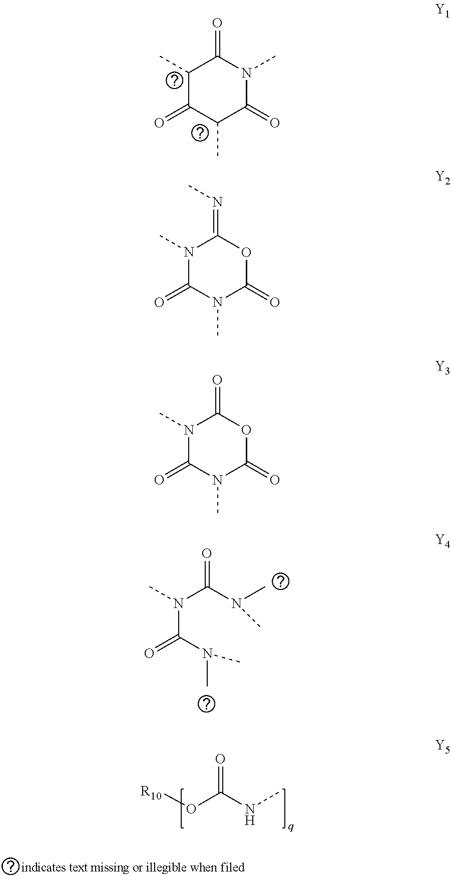

wherein
R₉ represents, independently, a hydrogen atom, a hydrocarbon group, a C₁-C₂₀ hydrocarbon group, a heterocarbon group comprising at least one heteroatom chosen from O, N, S and Si, a C₁-C₂₀ heterocarbon group comprising at least one heteroatom chosen from O, N, S and Si;
q represents an integer chosen from 3 or 4;
R₁₀ represents a group chosen from a hydrocarbon group, an alkyl group, a heterocarbon group, an aliphatic, cycloaliphatic, heterocyclic or aromatic heterocarbon group, comprising a function chosen from an isocyanate, carbamate, urea, biuret, uretinedione, acylurea, isocyanurate, blocked isocyanate or allophanate function, a group derived from pentaerythritol, a group derived from trimethylolpropane.

Preferentially, Y in general formula (VIII) is an isocyanurate group (Y₁) and/or biuret (Y₄).

In particular, the polyfunctional isocyanate (b2) can be:
a polyisocyanate isocyanurate (Y₁) resulting from a tricondensation reaction or
a polyisocyanate (Y₄) comprising between 1% and 99% by weight of biuret or preferentially between 2% and 75% by weight of biuret or
a polyisocyanate isocyanurate (Y₁) resulting from a tricondensation reaction and a polyisocyanate (Y₄) comprising between 1% and 99% by weight of biuret or preferentially between 2% and 75% by weight of biuret.

More preferentially, the polyfunctional isocyanate (b2) a group comprising at least one isocyanurate and/or a biuret wherein the groups are obtained from the oligomerisation of the following compounds: hexamethylene diisocyanate (HDI), isophorone diisocyanate (IPDI), bis(4,4′-isocyanatocyclohexyl)methane, 1,4-cyclohexylene diisocyanate, 1,3-bis(isocyanatomethyl)benzene (XDI), 1,3-bis(2-isocyanatoprop-2-yl)-benzene, 1,4-bis(2-isocyanatoprop-2-yl)-benzene (TMXDI), norbornane diisocyanate (NBDI), hydro-xylylene diisocyanate (H₆XDI), 1,4-cyclohexyl diisocyanate (H₆PPDI), 1,5-pentane diisocyanate (PDI) and/or dicyclohexylmethane diisocyanate.

The additive (c) is preferably chosen from: a wetting agent, a dispersant, a matting agent, an anti-foaming agent, a thickener, a molecular sieve, an elastomer, a pigment, a surfacing agent and a coalescing agent.

The amount of additives (c) added can vary in proportions known to those skilled in the art.

The invention also relates to a process for manufacturing a composition comprising the following steps:
1. preparing at least one polyaspartic ester (a),
2. preparing at least one isocyanate compound (b),
3. optionally preparing at least one additive (c),
4. mixing the preparations obtained in steps 1 and 2 and optionally 3.

In particular, the process for preparing a composition comprising the following steps:
1. preparing at least one polyaspartic ester (a),
2. preparing at least one isocyanate compound (b1) and at least one isocyanate compound (b2),
3. optionally preparing at least one additive (c),
4. mixing the preparations obtained in steps 1 and 2 and optionally 3.

Preferentially, the compounds (b1) and (b2) are mixed beforehand with each other before being mixed with the other compounds (a) and optionally the compounds (c).

Preferentially, the preparation of the compound (a) is mixed beforehand with the preparation of the additive(s) (c) before being mixed with the isocyanate compounds (b1) and (b2).

The different preparations of the compounds (a), (b) and optionally (c) or (a), (b1), (b2) and optionally (c) can be carried out in any order.

Another object of the invention is the use of a composition as an adhesive coating or as a protective coating of a substrate or a coated substrate.

Another object of the invention is an adhesive coating or a protective coating of a substrate or coated substrate comprising a composition.

Preferentially, the substrate or the coated substrate according to the invention is a floor, a roof, a waterproofing membrane, a wind turbine mast, an aircraft wing, a rotor blade, a propeller blade or a turbine blade.

### EXAMPLES

### Materials:

The product Feiyang F420 is a polyaspartic acid ester resin consisting of aliphatic rings substituted with secondary amines. This resin is similar to the Desmophen NH-1420 and Teraspartic 277 resins. Characteristics of Feiyang F420:
Equivalent amine (g/mol): 277
Dynamic viscosity at 25° C.: 1000-1500 mPas
Density: 1.06

The product Feiyang F520 is a polyaspartic acid ester resin consisting of aliphatic rings substituted with secondary amines. This resin is similar to the Desmophen NH-1520 and Teraspartic 292 resins. Characteristics of Feiyang F520:
Equivalent amine (g/mol): 290
Dynamic viscosity at 25° C.: 1200-1500 mPa·s
Density: 1.06

Tolonate HDT is an isocyanurate-type polyisocyanate prepared from hexamethylenediisocyanate.

Characteristics of Tolonate HDT:
NCO functionality: 21.5-22.5%,
Dynamic viscosity (at 25° C.): 2000-2800 mPa·s,
Density (at 25° C.): 1.16

Tolonate HDT-LV is an isocyanurate-type polyisocyanate prepared from hexamethylenediisocyanate.

Characteristics of Tolonate HDT-LV:
NCO functionality: 22-24%,
Dynamic viscosity (at 25° C.): 900-1500 mPa·s,
Density (at 25° C.): 1.16

Tolonate HDB is a biuret-type polyisocyanate prepared from hexamethylenediisocyanate. Characteristics of Tolonate HDB:
NCO functionality: 21-23%,
Dynamic viscosity (at 25° C.): 7000-11000 mPa·s,
Density (at 25° C.): 1.12

Tolonate HDB-LV is a biuret-type polyisocyanate prepared from hexamethylenediisocyanate. Characteristics of Tolonate HDB-LV:
NCO functionality: 22.5-24.5%,
Dynamic viscosity (at 25° C.): 1500-2500 mPa·s,
Density (at 25° C.): 1.12

HDT Dimer is an isocyanurate-type polyisocyanate prepared from hexamethylenediisocyanate.
NCO functionality: 22-24%,
Dynamic viscosity (at 25° C.): 450-750 mPa·s,
Density (at 25° C.): 1.13

Tolonate X-FLO 100 is an allophanate-type polyisocyanate prepared from hexamethylenediisocyanate.

Characteristics of Tolonate X-FLO 100:
NCO functionality: 11.3-13.3%,
Dynamic viscosity (at 25° C.): 60-220 mPa·s,
Density (at 25° C.): 1.04

Silosiv A3 is an additive useful as a molecular sieve.

Tego Airex 944 is an additive useful as an anti-foaming agent.

BYK 378 is an additive useful as a surfactant.

All the additives, polyisocyanates and resins used in the examples are commercially available products.

### Example 1: Preparation of compositions (A)

In order to prepare the compositions (A), the different products are weighed according to the proportions indicated in Table 1, then mixed using a Speedmixer until the mixture is homogenised.

Table 1 describes the proportions of each polyaspartic resin and additive according to each composition A.

TABLE 1

| | A1 | A2 |
|---|---|---|
| Compositions (A) | (% by mass) | (% by mass) |
| Feiyang F420 | 95.6 | 66.9 |
| Feiyang F520 | 0 | 28.7 |
| Silosiv A3 | 1.9 | 1.9 |
| Tego Airex 944 | 1.8 | 1.8 |
| BYK 378 | 0.7 | 0.7 |

### Example 2: Preparation of polyisocyanate compositions (B)

In order to produce the compositions (B), the mixtures are prepared according to the proportions described in Table 2. The polyisocyanate mixtures (B) are then homogenised for at least one night in a mixing unit.

The NCO content is measured by titration of the —NCO functions of each compound using a back titration of dibutylamine with a hydrochloric acid solution.

The viscosity is measured at 25° C. using an Anto-Paar viscometer with cone-plane geometry having an angle of 2°. The shear rate during measurement ranges from 0.1 to 100 s-1 with a rise and fall in the shear rate.

Low viscosity is defined by a viscosity less than 1500 mPa·s and a sufficient NCO content is defined by a value greater than 13%.

Table 2 presents the proportions of polyisocyanates, the viscosity and the NCO content according to each composition B.

TABLE 2

| | | HDT- | | HDB- | HDT- | X Flo | Viscosity | NCO |
|---|---|---|---|---|---|---|---|---|
| Compositions | HDT | LV | HDB | LV | Dimer | 100 | at 25° C. | content |
| (B) | (%) | (%) | (%) | (%) | (%) | (%) | (mPa · s) | (%) |
| B1 | 15 | | | | | 85 | 170 | 13.8 |
| B14 | 25 | | | | | 75 | 233 | 14.7 |
| B2 | 40 | | | | | 60 | 365 | 16.2 |
| B3 (comp.) | 100 | | | | | 0 | 2400 | 22.0 |
| B4 | | 15 | | | | 85 | 234 | 13.9 |
| B15 | | 25 | | | | 75 | 211 | 15 |
| B5 | | 40 | | | | 60 | 323 | 16.6 |
| B6 (comp.) | | 100 | | | | 0 | 1200 | 23.0 |
| B7 | | | 15 | | | 85 | 190 | 13.8 |
| B8 | | | 25 | | | 75 | 260 | 14.7 |
| B9 | | | 40 | | | 60 | 460 | 16.2 |
| B10 (comp.) | | | 100 | | | 0 | 9000 | 22.0 |
| B11 | | | | 15 | | 85 | 221 | 13.9 |
| B16 | | | | 25 | | 75 | 254 | 15.1 |
| B12 | | | | 40 | | 60 | 393 | 16.6 |
| B13 (comp.) | | | | 100 | | 0 | 2000 | 23.0 |
| B17 | | | | | 15 | 85 | 164 | 13.9 |
| B18 | | | | | 25 | 75 | 179 | 15.0 |
| B19 | | | | | 40 | 60 | 228 | 16.6 |
| B20 (comp.) | | | | | 100 | 0 | 600 | 23.0 |

As specified in Table 2, the compositions B3, B6, B10, B13 and B20 comprise 100% of each isocyanate. These are comparative examples (comp.).

The results show a decrease in viscosity with increasing amounts of Tolonate X-FLO 100 in the composition (B) used. The use of a proportion of Tolonate X-FLO 100 greater than or equal to 60% makes it possible to obtain compositions (B) with a viscosity of less than 1500 mPa·s at 25° C. and with an NCO content of more than 13%.

The comparative examples, although having an NCO content of more than 13%, have a viscosity greater than 1500 mPa·s, except for example B6.

### Example 3: Elongation of the compositions

Elongation is measured on coatings resulting from the mixture between the compositions (A) and the polyisocyanates (B) described in examples 1 and 2. This mixture is carried out using a Speedmixer to ensure good homogeneity, the formulations thus obtained are then crosslinked for 7 days in an enclosure regulated at 23° C. and 50% humidity. The mixing ratio between the compositions (A) and (B) is defined by an NCO/NH ratio that is equimolar, i.e., constant and equal to 1. The NH functionalities are present in the compositions (A) and the NCO functionalities are present in the polyisocyanates (B).

The elongation measurements are carried out using a traction machine (MTS) on specimens of standardised format (type 5A specimen of standard ISO 527-2) with a thickness between 1 and 2 mm. The traction speed is set at 10 mm/min.

The elongation at break corresponds to the elongation value reached when the specimen breaks. The sample is considered to have improved flexibility properties with an elongation at break of more than 50%.

Table 3 presents the elongation at break results for the different compositions A and B.

TABLE 3

| Compositions | Compositions | |
|---|---|---|
| (A) | (B) | Elongation (%) |
| A1 | B1 | 145 |
| | B2 | 110 |
| | B3 (comp.) | <20 |
| | B4 | 389 |
| | B5 | 55 |
| | B6 (comp.) | <20 |
| | B7 | 401 |
| | B8 | 230 |
| | B9 | 81 |
| | B10 (comp.) | — |
| | B11 | 470 |
| | B12 | 69 |
| | B13 (comp.) | <20 |
| | B14 | 221 |
| | B15 | 237 |
| | B16 | 228 |
| | B17 | 108 |
| | B18 | 264 |
| | B19 | 543 |
| | B20 (comp.) | <20 |
| A2 | B1 | 642 |
| | B2 | 219 |
| | B3 (comp.) | <20 |
| | B4 | 777 |
| | B5 | 188 |
| | B6 (comp.) | <20 |
| | B7 | 600 |
| | B8 | 405 |
| | B9 | 230 |
| | B10 (comp.) | — |
| | B11 | 647 |
| | B12 | 162 |
| | B13 (comp.) | <20 |
| | B14 | 484 |
| | B15 | 490 |
| | B16 | 450 |
| | B17 | 258 |
| | B18 | 532 |
| | B19 | 730 |
| | B20 (comp.) | <20 |

As specified in Table 3, the compositions comprising the polyisocyanate mixtures B3, B6, B10, B13 and B20 are comparative examples (comp.). These comparative examples stand out for their low flexibility (elongation at break well below 50%). Example B6, despite having a low viscosity, did not make it possible to obtain sufficient elongation at break (>50%). The elongation measurements in the mixtures containing the composition B10 could not be carried out due to the viscosity of the mixture being too high to be properly applied.

The composition has improved flexibility from a proportion by mass of Tolonate X-FLO 100 in the composition (B) greater than or equal to 60%. The effect is all the more marked with the use of a mixture containing composition (A2).

1. A composition for preparing coatings comprising:
at least one polyaspartic ester compound (a),
a mixture of isocyanate compounds (b), having an NCO content of more than 13% and the viscosity of which is less than 1500 mPa's at 25° C., comprising:
at least one allophanate (b1) and
at least one polyfunctional isocyanate (b2),
wherein the mass ratio (b1)/(b2) is between 50/50 and 99/1,
wherein the molar ratio (b)/(a) defined by the number of NCO functions for (b) and the number of NH functions for (a) is between 0.7 and 1.3,
optionally at least one additive (c).

2. The composition according to claim 1, wherein the polyaspartic ester (a) is a polyaspartic ester according to general formula (I):
wherein
X represents an aliphatic chain or a polyether chain,
R₁ and R₂ are, independently of each other, an organic group that is inert with respect to an isocyanate group at normal atmospheric pressure and at 100° C. or less,
n represents an integer greater than or equal to 2.

3. The composition according to claim 2, wherein the aliphatic residue X consists of one or more of the following residues chosen from a polyether residue, a linear alkyl residue, a branched alkyl residue and a cycloalkyl residue.

4. The composition according to claim 2, wherein the polyaspartic ester(s) (a) of general formula (I) are one or more polyaspartic ester(s) or a mixture of polyaspartic esters:
of general formula (II) and/or 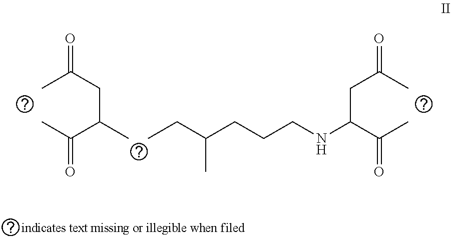
of general formula (III) and/or 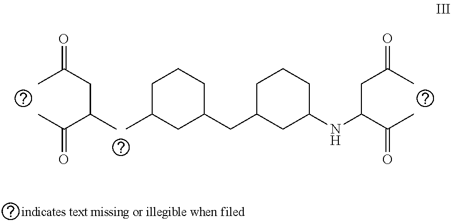
of general formula (IV) and/or 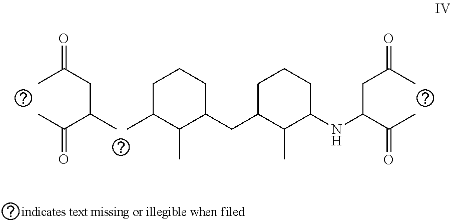
of general formula (V) 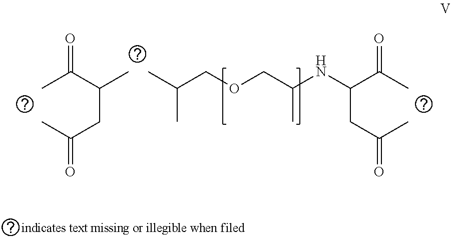
wherein the groups R₁ and R₂ are, independently of each other, a C₁-C₁₀ alkyl group and u is an integer between 1 and 10.

5. The composition according to claim 4, wherein the groups R₁ and R₂ are, independently of each other, one or more methyl, ethyl or butyl groups.

6. The composition according to claim 1, wherein the polyaspartic ester (a) is chosen from tetraethyl N,N′-(methylenedicyclohexane-4,1-diyl)bis-DL-aspartate, N,N′-(tetraethyl methylenebis(2-methyl-cyclohexane-4,1-diyl)bis-DL-aspartate or tetraethyl N,N′-(2-methylpentane)bis-DL-aspartate.

7. The composition according to claim 1, wherein the allophanate (b1) has an NCO functionality equal to 2.1+0.3 and of general formula (VI):
wherein
R₃ and R₄, which may be identical or different, represent a hydrocarbon group comprising at least one function selected from an isocyanate, carbamate, urea, biuret uretinedione, acylurea, isocyanurate, blocked isocyanate or allophanate function,
R₅ represents the residue of a molecule comprising an OH function after reaction of this OH function with an isocyanate function and the molecule of which containing an OH group can also comprise an ether or polyether function and chosen from a silanol, a C₁₂-C₂₀ linear aliphatic monoalcohol, a C₁₂-C₂₀ branched aliphatic monoalcohol, a C₂-C₄₀ linear diol or a C₃-C₄₀ branched diol of which at least one of the hydroxyl groups is substituted and which has general formula (VII): 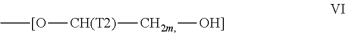
wherein T₁ represents a C₁-C₂₀ linear alkyl group, a C₁-C₂₀ branched alkyl group, a group of formula T₃—CO—CH₃ wherein T₃ represents a C₁-C₂₀ linear alkyl group or a C₁-C₂₀ linear alkyl group; T₂ represents hydrogen or an alkyl group or an ether group of formula —CH₂OT₄ wherein T₄ represents a hydrocarbon chain and m represents an integer ranging from 1 to 50.

8. The composition according to claim 7, wherein R³ and R₄, which may be identical or different, represent an aliphatic hydrocarbon group comprising at least one function chosen from an isocyanate, carbamate, urea, biuret uretinedione, acylurea, isocyanurate, blocked isocyanate or allophanate function.

9. The composition according to claim 1, wherein the compound (b2) is at least one polyfunctional isocyanate of general formula (VIII): 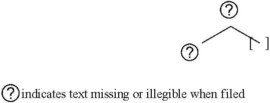
wherein
R₆, R₇ and R₈ independently represent a hydrocarbon group or an aliphatic, cycloaliphatic, heterocyclic or aromatic heterocarbon group, comprising at least one function chosen from an isocyanate, carbamate, urea, biuret uretinedione, acylurea, isocyanurate, blocked isocyanate or allophanate function,
p represents an integer chosen from 0, 1 or 2,
Y represents a group chosen from an isocyanurate group of formula (Y₁), an imino oxadiazine dione group of formula (Y₂), an oxadiazine trione group of formula (Y₃), a biuret group of formula (Y₄) or a group of formula (Y₅): 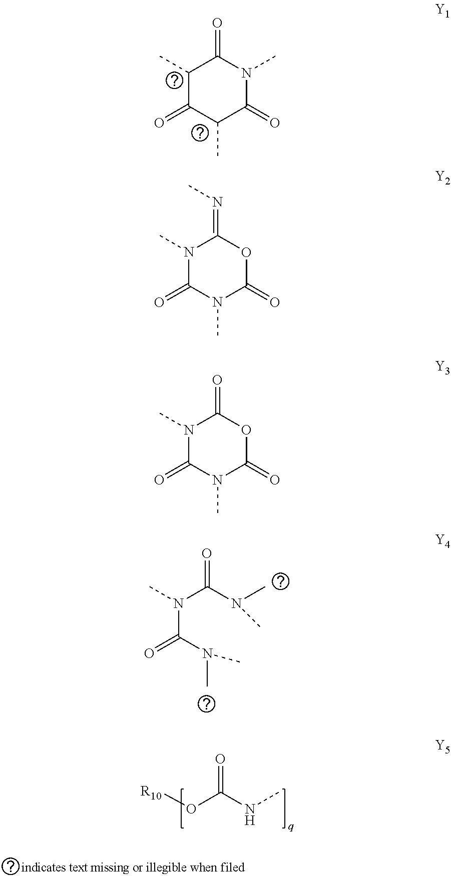
wherein
R₉ represents, independently, a hydrogen atom, a hydrocarbon group, a C₁-C₂₀ hydrocarbon group, a heterocarbon group comprising at least one heteroatom chosen from O, N, S and Si, a C₁-C₂₀ heterocarbon group comprising at least one heteroatom chosen from O, N, S and Si,
q represents an integer chosen from 3 or 4,
R₁₀ represents a group chosen from a hydrocarbon group, an alkyl group, a heterocarbon group, an aliphatic, cycloaliphatic, heterocyclic or aromatic heterocarbon group, comprising a function chosen from an isocyanate, carbamate, urea, biuret, uretinedione, acylurea, isocyanurate, blocked isocyanate or allophanate function, a group derived from pentaerythritol, a group derived from trimethylolpropane.

10. The composition according to claim 9, wherein the Y group is an isocyanurate (Y₁) and/or biuret group (Y₄).

11. The composition according to claim 10, wherein the polyfunctional isocyanate (b2) is a group comprising at least one isocyanurate and/or a biuret wherein the groups are obtained from the oligomerisation of the following compounds: hexamethylene diisocyanate (HDI), isophorone diisocyanate (IPDI), bis(4,4′-isocyanatocyclohexyl)methane, 1,4-cyclohexylene diisocyanate, 1,3-bis(isocyanatomethyl)benzene (XDI), 1,3-bis(2-isocyanatoprop-2-yl)-benzene, 1,4-bis(2-isocyanatoprop-2-yl)-benzene (TMXDI), norbornane diisocyanate (NBDI), hydro-xylylene diisocyanate (H₆XDI), 1,4-cyclohexyl diisocyanate (H₆PPDI), 1,5-pentane diisocyanate (PDI) and/or dicyclohexylmethane diisocyanate.

12. The composition according to claim 1, wherein the additive (c) is chosen from: a wetting agent, a dispersant, a matting agent, an anti-foaming agent, a thickener, a molecular sieve, an elastomer, a pigment, a surfacing agent and a coalescing agent.

13. A method for preparing the composition according to claim 1, comprising the following steps:
1. preparing at least one polyaspartic ester (a),
2. preparing at least one isocyanate compound (b1) and at least one isocyanate compound (b2),
3. optionally preparing at least one additive (c),
4. mixing the preparations obtained in steps 1 and 2 and optionally 3.

14. A use of a composition according to anyone of claim 1 as an adhesive coating or as a protective coating of a substrate or a coated substrate.

15. An adhesive coating or a protective coating of a substrate or coated substrate comprising a composition according to any of claim 1.

16. The coating according to claim 15, wherein the substrate or the coated substrate is a floor, a roof, a waterproofing membrane, a wind turbine mast, an aircraft wing, a rotor blade, a propeller blade or a turbine blade.
